(19) United States
(12) Patent Application Publication
(10) Pub. No.: US 2012/0158794 A1
(43) Pub. Date: Jun. 21, 2012

(54) TECHNIQUES TO DISCOVER OBJECT INTERFACES

(75) Inventors: Gabriel DeBacker, Redmond, WA (US); Dimiter Georgiev, Redmond, WA (US); Chris Guzak, Redmond, WA (US)

(73) Assignee: Microsoft Corporation, Redmond, WA (US)

(21) Appl. No.: 12/973,784

(22) Filed: Dec. 20, 2010

(51) Int. Cl. G06F 17/30

(52) U.S. Cl. 707/803; 707/E17.005; 707/E17.044

(57) ABSTRACT

Techniques to discover object interfaces are described. An object association component is operative to generate mapping information representing a mapping between an application object interface for an application object of an application program executing in a first process with a system object handle for a system object of a system program executing in a second process, create a memory map file name for a memory mapped file, and store a record with the mapping information in the memory mapped file. Other embodiments are described and claimed.

### BACKGROUND

Object-oriented programming (OOP) is a programming technique that uses objects to design software programs. An object may comprise a discrete set of data structures with a defined set of data fields, methods, properties and events. Each object is capable of receiving messages, processing data, and sending messages to other objects. The other objects may be executed in a same process or different processes. A process is an instance of a software program that is being executed. Depending on an operating system, a process may be implemented as one or more threads of execution that execute instructions from the software program concurrently.

Objects executed in different processes, or in some cases different threads of a single process, typically utilize some form of inter-process communication (IPC) to exchange data between the different processes. IPC techniques may include operations related to message passing, synchronization, shared memory, and remote procedure calls (RPC). Different IPC techniques may be used based on such factors as bandwidth and latency of communication between processes or threads of a process, and a type of data being communicated. Improvements in IPC techniques may lead to more efficient software programs and architectures. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to software programming techniques. Some embodiments are particularly directed to enhanced IPC techniques designed to improve communications between objects operating in different processes or processing threads. The enhanced IPC techniques allow one object running in one process (or thread) to easily discover and connect with another object running in a different process (or thread) in a secure and independent manner.

In one embodiment, for example, an apparatus may comprise a processor communicatively coupled to a memory. The memory may store an IPC component having an object association component and an object discovery component. The object association component may be arranged to generate mapping information representing a mapping between an application object and a system object. More particularly, the mapping information may represent an application object interface for an application object of an application program executing in a first process with a system object handle for a system object of a system program executing in a second process. The object association component may create a memory map file name for a memory mapped file, and store a record with the mapping information in the memory mapped file. The object discovery component allows the system object to discover the application object, such as in the event of a process crash, using information about the application object and/or the application object interface stored in the memory mapped file. This may be accomplished by allowing the system object to generate the memory map file name using a known piece of information, such as the system object handle. In this manner, the system object may generate the memory map file name independent of the application object, thereby eliminating any need to communicate with the application object to retrieve the memory map file name prior to accessing the memory mapped file. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of an IPC system.

FIG. 2 illustrates an embodiment of an IPC component.

FIG. 3 illustrates an embodiment of a memory mapped file.

FIG. 4A illustrates an embodiment of a user interface view.

FIG. 4B illustrates an embodiment of a modified user interface view.

FIG. 5 illustrates an embodiment of a first logic flow.

FIG. 6 illustrates an embodiment of a second logic flow.

FIG. 7 illustrates an embodiment of a computing architecture.

### DETAILED DESCRIPTION

Various embodiments are directed to enhanced IPC techniques to facilitate discovery and communications of objects operating in different processes, or different threads of a single process. Some embodiments utilize a memory mapped file to store information useful in discovery operations, such as information about an object and/or an interface for an object. In one embodiment, the memory mapped file may store information about an application object and application object identifier, such as an application interface identifier (IID), for example. The memory mapped file has a unique and creatable memory map file name that can be automatically generated by either object in either thread utilizing a single piece of shared data (e.g., a unique identifier such as an object handle). In this manner, different objects executing in different processes (or threads) can discover and connect to each other directly without having to send messages through other objects or programs. As a result, the embodiments can improve affordability, scalability, modularity, extendibility, or interoperability of a software program.

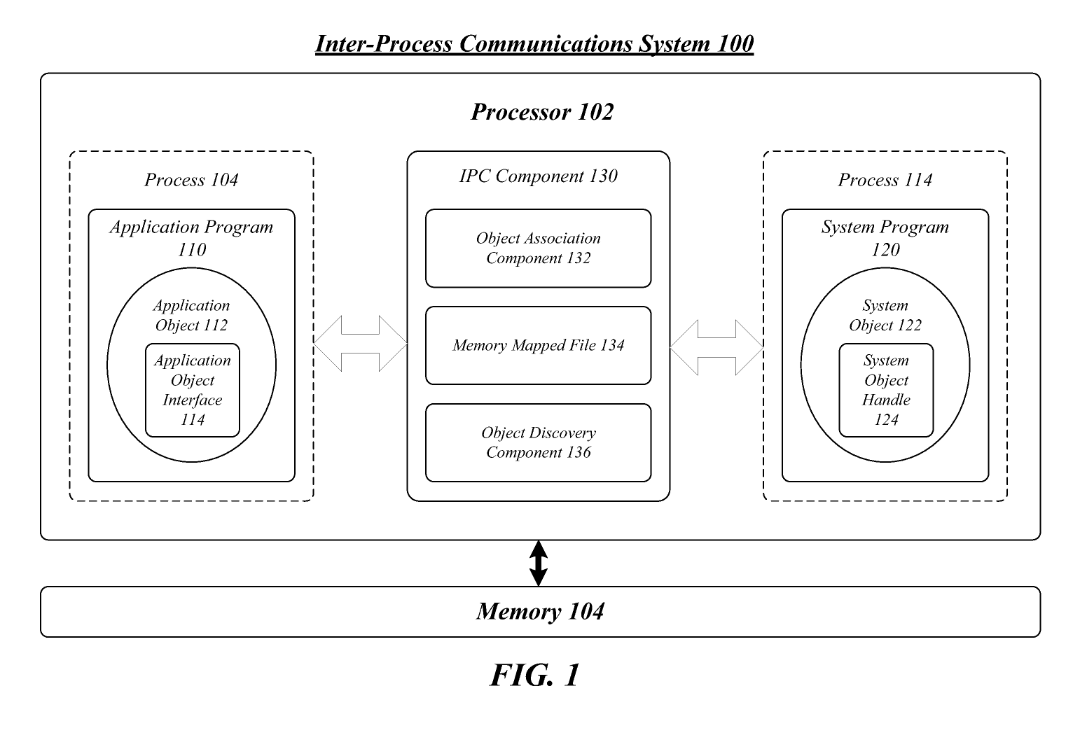

FIG. 1 illustrates a block diagram for an IPC system 100 comprising or implementing enhanced IPC techniques to facilitate discovery and communications between different software programs and their associated objects. In one embodiment, for example, the IPC system 100 may comprise a computer-implemented IPC system 100 having multiple components 130, 132 and 136. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the IPC system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, gaming device, programmable consumer electronics, television, digital television, set top box, wireless access point, base station, subscriber station, mobile subscriber center, radio network controller, router, hub, gateway, bridge, switch, machine, or combination thereof. Although the IPC system 100 as shown in FIG. 1 has a limited number of elements in a certain topology, it may be appreciated that the IPC system 100 may include more or less elements in alternate topologies as desired for a given implementation.

The components 130, 132 and 136 may be communicatively coupled via various types of communications media. The components 130, 132 and 136 may coordinate operations between each other. The coordination may involve the uni-directional or bi-directional exchange of information. For instance, the components 130, 132 and 136 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, for example, the IPC system 100 may comprise or implement a processing system, such as a processor 102 communicatively coupled to a memory 104. The memory 104 may store an IPC component 130. The processor 102 (or another processor) may execute the IPC component 130 to generally manage IPC operations between various software programs and associated objects executing in different processes or processing threads. For instance, the IPC component 130 may allow objects from one software program to discover, connect and communicate with objects from another software program using shared memory techniques and unique name assignments.

A software program may be implemented in accordance with a given OOP architecture, reference or model. In general, an object may comprise a discrete set of data structures with a defined set of data fields, methods, properties and events. Each object is capable of receiving messages, processing data, and sending messages to other objects. In other words, each object can be viewed as an independent “machine” with a distinct role or responsibility. As such, a software program may represent a collection of interacting objects.

A process is an instance of a software program that is being executed. It contains the program code and its current activity. Depending on the operating system (OS), a process may be made up of multiple threads of execution that execute instructions concurrently. A software program is a passive collection of instructions stored in the memory 104. A process is the actual execution of those instructions by the processor 102. Several processes may be associated with the same software program. For example, opening up several instances of the same program often means more than one process is being executed.

In various embodiments, the processor 102 may be arranged to execute different software programs in different processes. In the illustrated embodiment shown in FIG. 1, for example, the processor 102 executes an application program 110 in a first process 104 and a system program 120 in a second process 114. An example for the application program 110 may comprise a productivity program from a suite of independent or inter-related applications (e.g., word processor, spreadsheet, presentation, drawing, database, notes, etc.), such as MICROSOFT® OFFICE made by Microsoft Corporation, Redmond, Wash. An example for the system program 120 may comprise an operating system (OS) and associated graphical user interface (GUI) implemented for an electronic device as previously described above (e.g., a computing device), such as MICROSOFT WINDOWS® made by Microsoft Corporation, Redmond, Wash. It may be appreciated that these are merely examples for the software programs 110, 120, and any software programs in need of inter-process communications support may be used for a given implementation. The embodiments are not limited in this context.

It is worthy to note that although FIG. 1 illustrates a single processor 102 executing different threads 104, 114, it may be appreciated that different processors may each execute the different threads 104, 114. Further, although FIG. 1 shows the processor 102 executing different processes 104, 114, it may be appreciated that a single process may have different processing threads utilizing the IPC component 130.

When executed, the software programs 110, 120 may each instantiated one or more objects during runtime that are designed to interact with each other. As shown, the application program 110 may instantiate an application object 112, and the system program 120 may instantiate a system object 122. An example for the application object 112 may comprise a document object to render a document. An example of a system object 122 may comprise a window object for a GUI to present the document object. Other objects are possible. It may be appreciated that the objects 112, 122 may have characteristics common to each other and software objects in general, including a discrete set of data structures with a defined set of data fields, methods, properties and events. Further, the objects 112, 122 are capable of receiving messages, processing data, and sending messages to other objects, including each other.

The application object 112 may further include an application object interface 114. The application object interface 114 may generally comprise an interface for passing messages with another object. For instance, if the application object 112 is a document for a word processor, the application object interface 114 may be used to receive keystrokes from an input device for display on the document. In various embodiments, the application object interface 114 may conform to an object model and set of programming parameters that enable the application object 112 to interact with other objects, such as the system object 122, for example. In one embodiment, for example, the application object interface 114 may be implemented as a Microsoft Component Object Model (COM) interface. A COM interface is a set of related functions or methods that allow access to the application object 112. A COM interface is typically accessed through a pointer to the COM interface. Other object interfaces may be implemented for the application object 112 consistent with different types of object models and programming parameters as well. The embodiments are not limited in this context.

The system object 122 may further include a system object handle 124. The system object handle 124 is a unique identifier assigned by the system program 120 to each system object it creates. The system object handle 124 may be used to uniquely identify the system object 124 so that is may be used by other objects, such as the application object 112. The system object handle 124 may have “object names” assigned to them in a way that can be recreated by both a program exposing an object interface and a program consuming the object interface. In one embodiment, for example, the system program 120 may be implemented as a MICROSOFT WINDOWS OS, the system object 122 may be implemented as a window object for its GUI, and the system object handle 124 may comprise a windows handle (HWND). A given HWND is unique in that it may not be assigned to two system objects at the same time.

Since the objects 112, 122 execute in different processes 104, 114 (or in some cases different threads of a single process), the objects 112, 122 may need some form of inter-process communication (IPC) to exchange data across the processing boundaries of the different processes 104, 114. To this end the IPC component 130 may implement various enhanced IPC techniques to support operations related to message passing, synchronization, shared memory, and remote procedure calls (RPC). As shown, the IPC component 130 may comprise, among other elements, an object association component 132, a memory mapped file 134, and an object discovery component 136. In various embodiments, the IPC component 130, the object association component 132 and/or the object discovery component 136 may be implemented as one or more application program interface (APIs) stored as part of a software library available to a calling program, such as the application program 110 and the system program 120, for example. The embodiments, however, are not limited to this type of implementation. In one embodiment, the APIs may be in binary form for runtime execution.

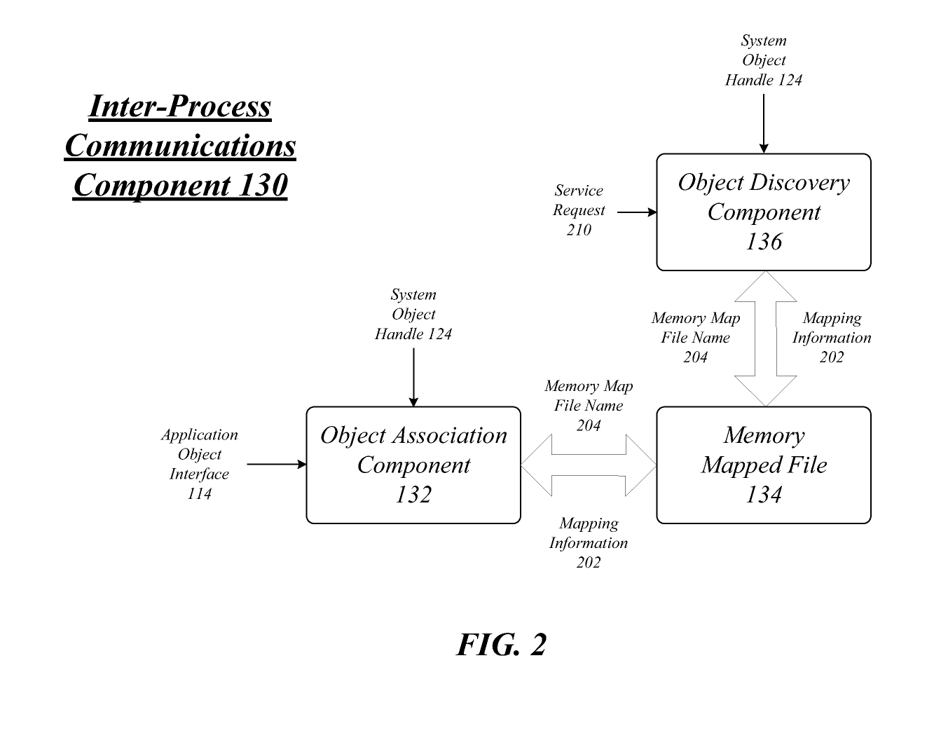

FIG. 2 illustrates a more detailed block diagram for the IPC component 130. More particularly, FIG. 2 illustrates an exemplary information flow between the object association component 132, the memory mapped file 134, and the object discovery component 136. The information can be implemented as signals allocated to various signal lines. In such allocations, each message is a signal. Alternative embodiments, however, may employ data messages. Such data messages may be sent across various connections. Exemplary connections include parallel interfaces, serial interfaces, and bus interfaces.

The object association component 132 may be generally arranged to associate various objects together so that they can interact or interoperate with each other, either as observer/subject objects or client/server objects, for example. The association may include various types of information useful for establishing and removing connections between objects. In one embodiment, for example, the processor 102 may execute the object association component 132 to generate mapping information 202 representing some form of mapping or association between the objects 112, 122. For instance, the mapping information 202 may comprise information (e.g., pointers, references, handles, monikers, etc.) mapping the application object interface 114 of the application object 112 of the application program 110 executing in the first process 104 with the system object handle 124 of the system object 122 of the system program 120 executing in the second process 114.

The object association component 132 may create a memory mapped file 134 to store the mapping information 202. The memory mapped file 134 may comprise a portion of shared memory in the memory 104 accessible by the software programs 110, 120. The memory mapped file 134 contains contents of a file in virtual memory. This mapping between a file and memory space enables software programs, including multiple processes, to modify the file by reading and writing directly to the virtual memory. The memory mapped file 134 may store mapping information 202 and is backed by a paging file. The paging file will be have a system access control list (SACL) set on it that does not allow processes running at lower integrity levels to access the paging file, and hence the exposed services and interfaces. Techniques for managing integrity levels may include access control entry (ACE) integrity techniques, among others.

The memory mapped file 134 can be shared across multiple processes. As such, the software programs 110, 120 may share data across process boundaries via the memory mapped file 134. For instance, the application program 110 may write some data to the memory mapped file 134 and the system program 120 may read the data from the memory mapped file 134, and vice-versa. In one embodiment, the memory mapped file 134 may comprise or be implemented as an array of records, with each record having a set of mapping information 202 and any associated fields (e.g., headers, terminators, metadata, etc.).

In one embodiment, the memory mapped file 134 may be created and managed by the application program 110, that is, the application program 110 calls the object association component 132. In this manner, the memory mapped file 134 will remain discoverable in a scenario where the system program 120 and/or the system object 122 have an unexpected shut-down or abnormal termination event. The system program 120 may restart and re-instantiate the system object 122. The system program 120 and/or the system object 122 may then attempt to discover the application object 112 using the object discovery component 136. Alternatively, the memory mapped file 134 may be created and managed by the system program 120. However, it is a likely scenario that if the application program 110 were to have an unexpected shut-down or restart event, associated system objects would be shut-down as well, and re-instantiated once the application program 110 restarts, thereby having less need for discovery operations between objects. The embodiments are not limited in this context.

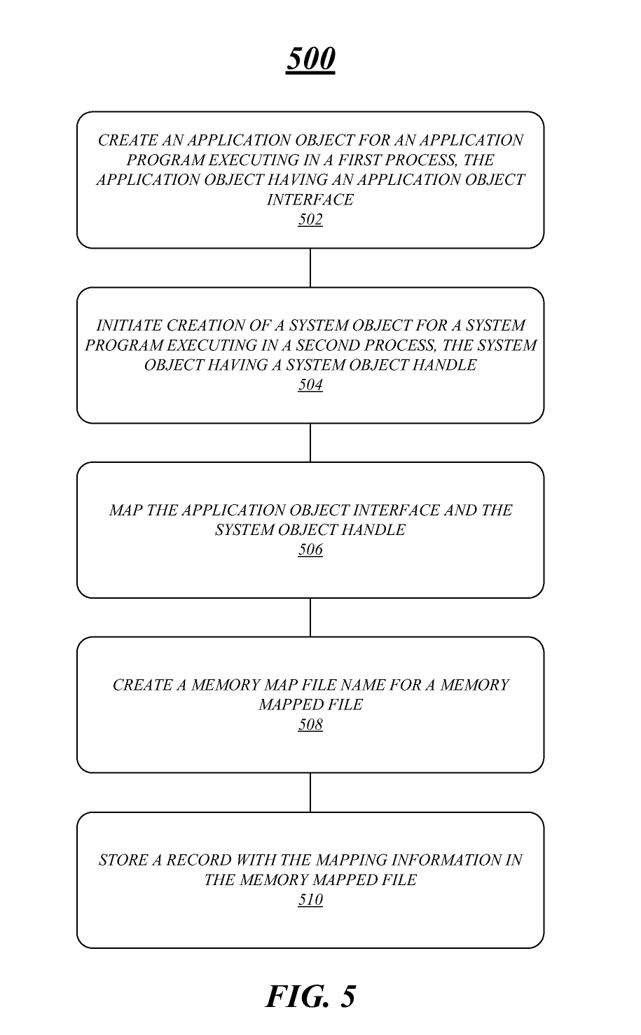

When called, the object association component 132 may create the memory mapped file 134 and a memory map file name 204 for the memory mapped file 134. The memory map file name 204 comprises a unique identifier for the memory mapped file 134. In one embodiment, the memory map file name 204 is creatable by objects 112, 122 in both processes 104, 114, while maintaining sufficient uniqueness to avoid collisions with other processes. In one embodiment, the memory map file name 204 may be created using the system object handle 124 of the system object 122, as described further below with reference to FIG. 5.

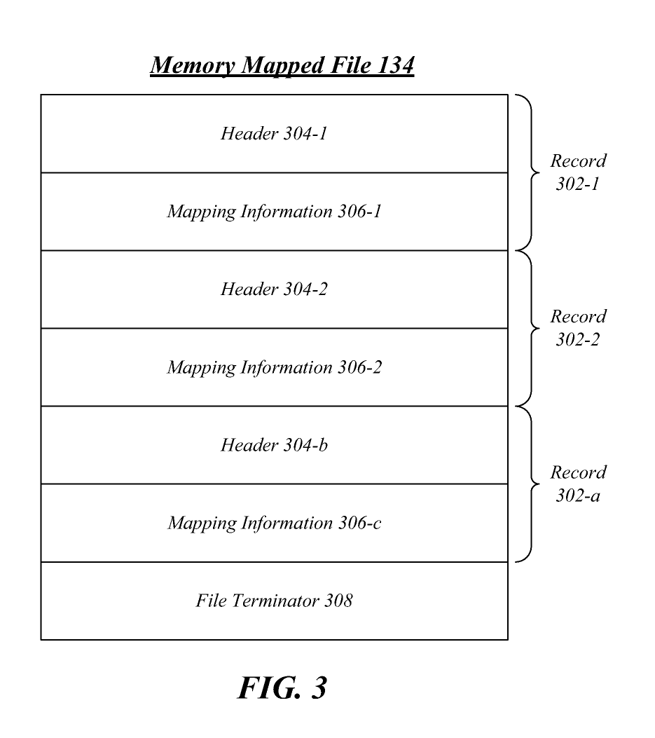

The object association component 132 may store a record with the mapping information 202 in the memory mapped file 134. Once the memory mapped file 134 has been created, the object association component 132 may store one or more records each having mapping information 202 for associated objects (e.g., the objects 112, 122) in the memory mapped file 134. An example for the memory mapped file 134 and its stored records may be described in more detail with reference to FIG. 3.

Once the object association component 132 creates the memory mapped file 134 and stores a record with mapping information 202, the object discovery component 136 may be used to retrieve the mapping information 202 from the memory mapped file 134. The object discovery component 136 allows the system object 122 to discover the application object 112, such as in the event of a system crash, using the memory mapped file 134. This may be accomplished by allowing the system object 122 to generate the memory map file name 204 using a known piece of information, such as the system object handle 124 (e.g., HWND). In this manner, the system object 122 may generate the memory map file name 204 independent of the application object 112, meaning that the system object 122 does not need to query the application object 112 to retrieve the memory map file name 204 prior to accessing the memory mapped file 134.

In the illustrated embodiment shown in FIG. 2, for example, the object discovery component 136 receives a service request 210, determines the system object handle 124 for the system object 122, and creates the memory map file name 204 for the memory mapped file 134 using the system object handle 124. As the system object 122 is created by the system program 120, which assigns the system object handle 124 to the system object 122, the object discovery component 136 may retrieve the system object handle 124 from within the same address space as used by the process 114. To create the memory map file name 204, the object discovery component 136 may call the same API used to originally create the memory map file name 204, passing the system object handle 124 as an input parameter for the API signature. Alternatively, the object discovery component 136 may use the same or similar logic as this API to reproduce the memory map file name 204 using just the system object handle 124. The object discovery component 136 may then use the memory map file name 204 to locate the memory mapped file 134, and retrieve the record with the mapping information 202 from the memory mapped file 134. The object discovery component 136 may decode the mapping information 202 to find a pointer, reference, handle or other location information for the application object interface 114 of the application object 112. The object discovery component 136 may return the location information to the system object 122. The system object 122 may use the location information to discover the application object 112 and its application object interface 114, and establish a message connection between the application object 112 and the system object 122 using the application object interface 114.

FIG. 3 illustrates an example for the memory mapped file 134. In the illustrated embodiment shown in FIG. 3, the memory mapped file 134 may comprise an array of records 302-a. Each record 302-a may comprise a data structure having a header 304-b and a set of mapping information 306-c. The mapping information 306-c may represent, for example, the mapping information 202.

It is worthy to note that “a” and “b” and “c” and similar designators as used herein are intended to be variables representing any positive integer. Thus, for example, if an implementation sets a value for a=5, then a complete set of records 302-a may include records 302-1, 302-2, 302-3, 302-4 and 302-5. The embodiments are not limited in this context.

The header 304-b may delineate a start of a record 302-a having a set of mapping information 306-c. In one embodiment, each header 304-b may comprise a signature, a size for the mapping information 306-c, and a service identifier. This may be illustrated in Table 1 as follows:

TABLE 1

| | | |
|---|---|---|
| DWORD | dwSig | “WSVC” |
| ULARGE_INTEGER | cbStreamSize | Marshaled Stream Size |
| GUID | Serviced | Service Identifier |

Following the header 304-b is the mapping information 306-c. As illustrated, the memory mapped file 134 may include an array with at least two records, including a record 302-1 comprising the header 304-1 and the mapping information 306-1, and a record 302-2 comprising the header 304-2 and the mapping information 306-2.

An array may be terminated with a special data structure indicated as a file terminator 308. In one embodiment, the file terminator 308 may be implemented as a header 304-b, with the header 304-b having a valid signature, a stream size set to zero (0), and a service identifier set to GUID_NULL. Other file terminators may be used as well.

Once created, the memory mapped file 134 is left open in the registering process, and each record 302-a is stored in a global list that maintains a mapping between a system object handle 124 (e.g., HWND), an application object interface 114 (e.g., an interface identifier), and a file mapping handle identifying the record 302-a. This global list may be stored in a thread local storage (TLS) slot and is therefore per thread. The file mapping handle only has meaning to the originating process and is used when unregistering interfaces.

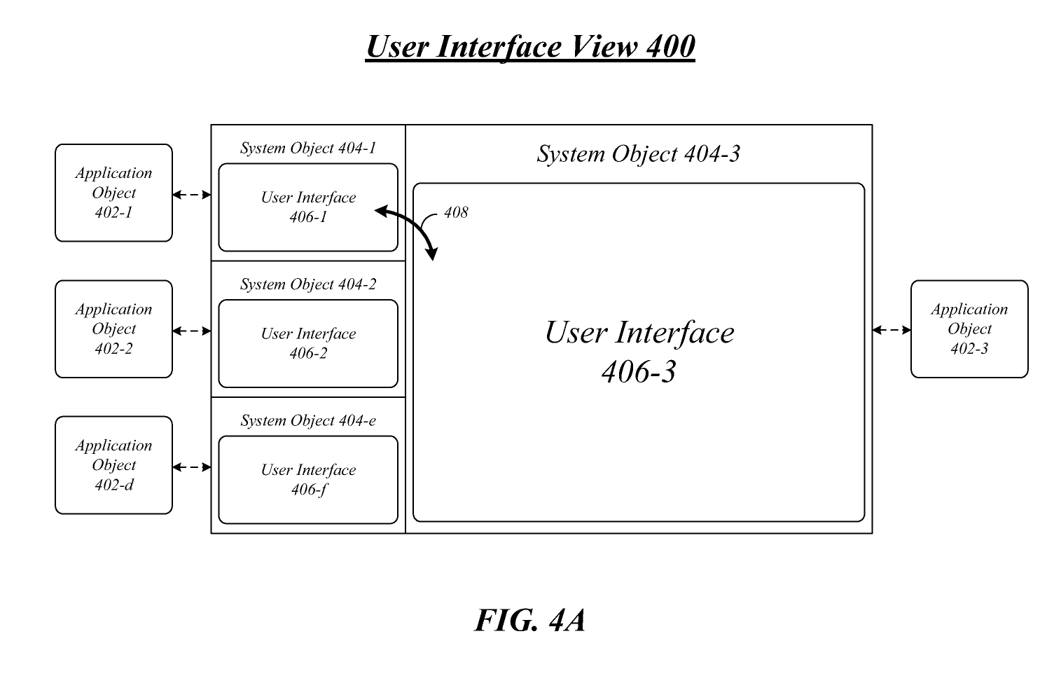

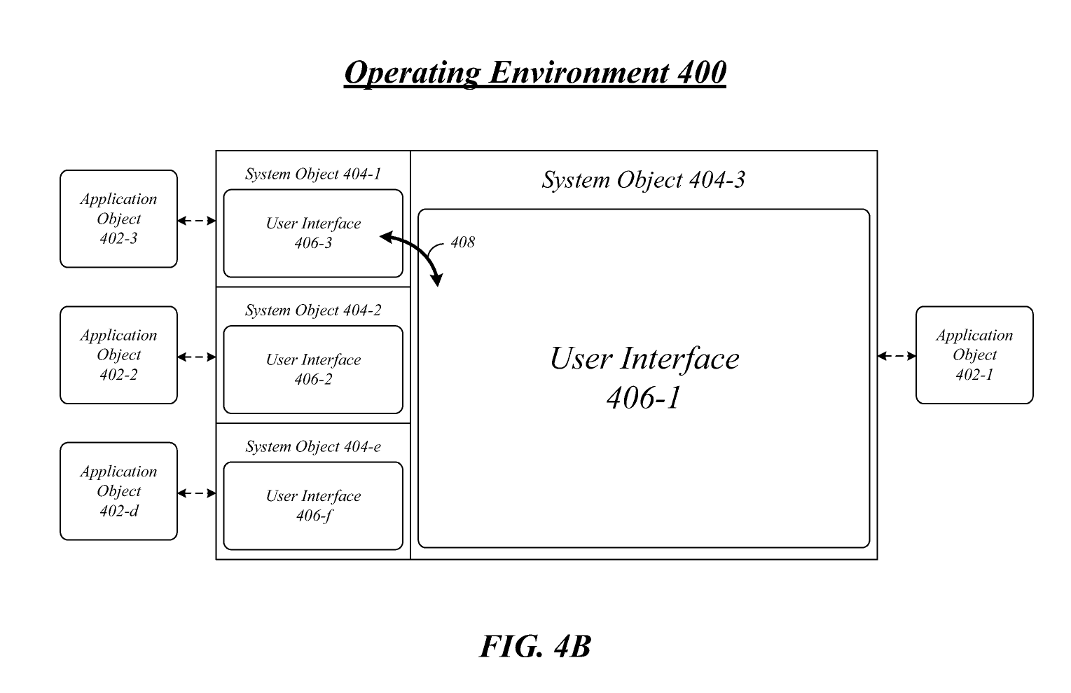

FIG. 4A illustrates a user interface view 400 suitable for using the IPC system 100. As shown in FIG. 4A, the user interface view 400 illustrates multiple application objects 402-d representative of the application object 112. Assume each of the application objects 402-d corresponds to different application programs, similar to the application program 110, and are arranged to present a user interface 406-f for a corresponding application program. Further assume each of the application objects 402-d is associated with, or mapped to, a corresponding system object 404-e using the IPC component 130. For instance, each system object 404-e may be representative of the system object 122 and may be implemented as a GUI window generated by the system program 120.

In operation, each of the application objects 402-d may operate to present a respective user interface 406-f in a respective window of a system object 404-e. For instance, the application object 402-1 may present the user interface 406-1 in the system object 404-1, and the application object 402-3 may present the user interface 406-3 in the system object 406-3. As shown, assume the system object 404-3 is a larger window than the system objects 404-1, 404-2 . . . 404-e. This may occur because the system object 404-3 is a primary window, while the other system objects 404-1, 404-2 . . . 404-e are secondary windows. This may be desirable when the user interface view 400 is presented on an electronic device having a processing system designed to allow multiple application programs to concurrently run, and allow a user to switch application objects 402-d and associated user interfaces 406-f between the primary window and secondary windows of the system objects 404-e, as indicated by arrow 408. The user interface view 400 may provide various GUI tools allowing control of the user interface view 400 (e.g., pointers, buttons, gestures, etc.).

FIG. 4B illustrates a user interface view 400 suitable for using the IPC system 100. FIG. 4B illustrates the user interface view 400 when a user switches the application object 402-1 and associated user interface 406-1 from the system object 404-1 to the system object 404-3, and vice-versa. To accomplish this, the system program 120 may use the IPC component 130 to remove the existing connection between the application object 402-1 and the system object 404-1, and establish a new connection between the application object 402-1 and the system object 404-3, and vice-versa. Alternatively, the system program 120 may generate a new system object 404-e (e.g., system object 404-5) similar to the system object 404-3 for the application object 402-1 to replace the system object 404-3.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

FIG. 5 illustrates one embodiment of a logic flow 500. The logic flow 500 may be representative of some or all of the operations executed by one or more embodiments described herein, such as the object association component 132 of the IPC component 130, for example.

In the illustrated embodiment shown in FIG. 5, the logic flow 500 may create an application object for an application program executing in a first process, the application object having an application object interface at block 502. For example, the application program 110 may create one or more application objects 112 executing in the first process 104, with each application object 112 having an application object interface 114.

The logic flow 500 may initiate creation of a system object for a system program executing in a second process, the system object having a system object handle at block 504. For example, the application program 110 and/or the application object 112 may initiate creation of the system object 122 for the system program 120 executing in the second process 114, the system object 122 having the system object handle 124. In one embodiment, the system object handle 124 may comprise a HWND assigned by the system program 120.

The logic flow 500 may map the application object interface and the system object handle at block 506. For example, the application program 110 and/or the application object 112 may call the object association component 132 to map the application object interface 114 and the system object handle 124.

The object association component 132 may allow the application program 110 to register the application object interface 114 and other services for the application object 112 on the system object 122 that is “owned” by the application program 110. This allows other processes in the IPC system 100 to discover and use the registered interfaces and services. The application program 110 can expose the application object interface 114 for the application object 112 by calling a registration API to associate the application object interface 114 with the system object handle 124 (e.g., HWND). Once this has been accomplished, any process that has knowledge of the system object handle 124 can acquire the application object interface 114 for use in a given scenario.

In one embodiment, the object association component 132 may perform registration operations using a set of COM APIs. Unregistering an interface essentially reverses the registration operations.

By way of example, the application program 110 may associate a service with a HWND through a RegisterWindowService API having a signature as follows:

STDAPI RegisterWindowService (_in HWND hwnd,

_in REFGUID serviceId,
_in IUnknown *punk);

Pseudo-code for RegisterWindowService is as follows (without error checking for brevity):

```
STDAPI RegisterWindowService (_in HWND hwnd,
                            _in REFGUID serviceId,
                            _in IUnknown *punk);
```

The application program 110 may initialize COM on the appropriate thread and register the application object interface 114 during creation of the system object 122, as follows:

```
int APIENTRY wWinMain(_in HINSTANCE hInstance,
          _in_opt HINSTANCE,
          _in PWSTR,
          _in int nCmdShow)
{
  if (SUCCEEDED(CoInitialize(NULL)))
  {
    if (SUCCEEDED(CreateApplicationWindow(hInstance,
    nCmdShow)))
    {
      MSG msg;
      while (GetMessage(&msg, NULL, 0, 0))
      {
        TranslateMessage(&msg);
        DispatchMessage(&msg);
      }
    }
    CoUninitialize( );
  }
  return 0;
}
LRESULT CALLBACK WndProc(HWND hWnd, UINT message,
WPARAM wParam, LPARAM lParam)
{
  switch (message)
  {
  case WM_NCCREATE:
    {
      IObjectProvider *pProvider;
      _CreateObjectProvider(&pProvider);
      RegisterWindowService(hWnd,
              SID_SomeSystemService,
              pProvider);
    }
    break;
```

The application program 110 may query the system program 120 for an interface using a QueryWindowService API having a signature as follows:

STDAPI QueryWindowService(_in HWND hwnd,

_in REFGUID serviceId,
_in REFIID riid,
_deref_out void **ppvObject);

Psuedo-code for QueryWindowService is as follows:

```
STDAPI QueryWindowService(_in HWND hwnd,
                          _in REFGUID serviceId,
                          _in REFIID riid,
                          _deref_out void **ppvObject);
```

During registration operations, the object association component 130 may perform COM marshaling operations to create a marshaled COM interface stream representing the mapping information 202, 306-c. A marshaled COM interface stream may comprise a series of bytes representing a marshal data packet. The marshal data packet may comprise such data fields for information such as, for example, a signature (e.g., a Microsoft Extended Object Wire or “MEOW” signature), one or more flags, an interface identifier (IID), a CLSID, optional reserved data, a data byte count, and custom marshal data (e.g., initialization data for a custom proxy). Other data fields may be used as well. The marshaled COM interface stream may be stored as part of a record 302-a of the memory mapped file 134. The system program 120 may use the object discovery component 136 to locate the memory mapped file 134, locate a given marshaled COM interface stream, and perform un-marshal operations to acquire an IID for the application object interface 114.

The logic flow 500 may create a memory map file name for a memory mapped file at block 508. For example, the object association component 132 may create the memory map file name 204 for the memory mapped file 134.

In one embodiment, the memory map file name 204 may be created using the system object handle 124 of the system object 122. The system object handle 124 provides a suitable level of uniqueness, particular for a HWND, as no two processes can contain the same handle value at the same time. Therefore utilizing a HWND as part of the memory map file name 204 ensures at least a similar level of uniqueness as that given to the HWND. An example of an application program interface (API) suitable to create a memory map file name in a form “HWNDInterface: [HWND]” for the memory mapped file 134 is shown as follows:

```
static const wchar_t _gszHwndInterfacePrefix[ ] = L“HWNDInterface:”;
HRESULT _CreateFileMappingName(_in HWND hwnd,
          _out_ecount(cchName) PWSTR pszName,
          _in_range(>, 0) unsigned int cchName)
{
  wchar_t szGuid[40];
  StringFromGUID2(riid, szGuid, ARRAYSIZE(szGuid));
  return StringCchPrintf(pszName,
        cchName,
        L“%s%llx”,
        _gszHwndInterfacePrefix,
        reinterpret_cast<unsigned long long>(hwnd));
```

The logic flow 500 may store a record with the mapping information in the memory mapped file at block 510. For example, the object association component 132 may store a record 302-a with the mapping information 306-c in the memory mapped file 134.

Continuing with the previous COM example, during registration of the application object interface 114, the system object handle 124 or HWND is verified as belonging to the calling process, which here is the application program 110. The application object interface 114 will then be marshaled into a marshaled COM interface stream (e.g., IStream) using a CoMarshalInterface method indicating local machine use since HWNDs have no meaning between machines. The marshaling information stored in the marshaled COM interface stream will then be saved in the memory mapped file 134. The memory map file name 204 of the memory mapped file 134 will be the same identifier returned by a CreateFileMappingName method. This enables reading of the marshaling information by other processes.

Then the memory mapped file will have a SYSTEM_MANDATORY_LABEL_ACE applied to it specifying SYSTEM_MANDATORY_LABEL_NO_READ_UP|SYSTEM_MANDATORY_LABEL_NO_WRITE_UP. This will ensure that applications running at a lower integrity level than the calling application will not have access to interfaces registered to the higher integrity level application.

The memory mapped file 134 will typically contain more than one marshaled COM interface stream, depending on the number of services associated with a window. The memory mapped file 134 essentially contains an array of marshaled COM interface streams, as described with reference to FIG. 3. An example of a definition for a class to maintain this mapping is as follows:

```
class CHWNDMap
{
  CHWNDMap( ) : _tlsSlot(TlsAlloc( ))
  {
  }
  HRESULT AddMapping(_in HWND const hwnd, _in REFGUID
serviceId, _in HANDLE const hMapping) const;
  HRESULT RemoveAll(_in HWND const hwnd) const;
  HRESULT RemoveMapping(_in HWND const hwnd, _in REFGUID
serviceId, HANDLE *phFileMapping) const;
  struct HWND_FILEMAPPING
  {
    HWND const _hwnd;
    GUID _serviceId;
    HANDLE const _hFileMapping;
  };
  DWORD const _tlsSlot;
};
```

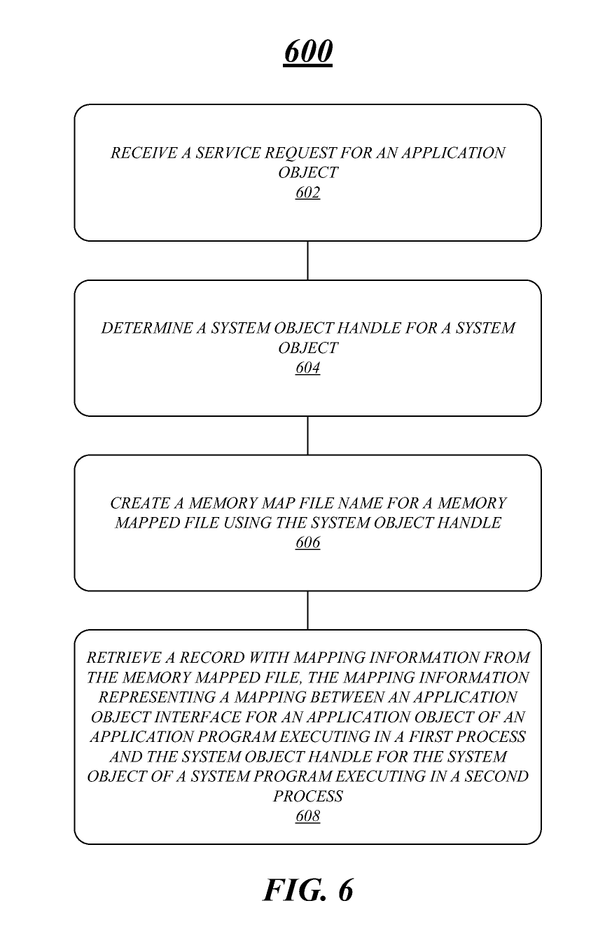

FIG. 6 illustrates one embodiment of a logic flow 600. The logic flow 600 may be representative of some or all of the operations executed by one or more embodiments described herein, such as the object discovery component 136 of the IPC component 130, for example.

In the illustrated embodiment shown in FIG. 6, the logic flow 600 may receive a service request for an application object at block 602. For example, the object discovery component 136 may receive the service request 210 (e.g., API call) for an application object 112.

The logic flow 600 may determine a system object handle for a system object at block 604. For example, the object discovery component 136 may determine the system object handle 124 for the system object 122. The object discovery component 136 may determine the system object handle 124 using information provided by the system program 120 that assigned the system object handle 124 to the system object 122.

The logic flow 600 may create a memory map file name for a memory mapped file using the system object handle at block 606. For example, the object discovery component 136 create (or re-create) the memory map file name 204 for the memory mapped file 134 using the system object handle 124.

The logic flow 600 may retrieve a record with mapping information from the memory mapped file, the mapping information representing a mapping between an application object interface for the application object of an application program executing in a first process and the system object handle for the system object of a system program executing in a second process at block 608. For example, the object discovery component 136 may retrieve a record 302-a with mapping information 306-c from the memory mapped file 134. The mapping information 306-c may represent a mapping between the application object interface 114 for the application object 112 of the application program 110 executing in the first process 104 and the system object handle 124 for the system object 122 of the system program 120 executing in the second process 114.

Continuing with the previous example of FIG. 5, the object discovery component 136 may construct the memory map file name 204 (and IID) using the same CreateFileMappingName method as used by the object association component 132 to originally create the memory map file name 204. The object discovery component 136 may locate the memory map file name 204, and reconstitute the marshaling information into an IStream from the memory mapped file 134 using the IID. The application object interface 114 is un-marshaled using a CoMarshalInterface API.

In the event of an abnormal application termination, the IPC component 130 may be arranged to ensure that OS resources are correctly cleaned up. For instance, the memory mapped file 134 will be properly cleaned up by the kernel when the process terminates and the last handle to the memory mapped file 134 is closed. The implementation of these APIs only holds the memory mapped file 134 open long enough to read the data from the memory mapped file 134 and place it into an IStream. COM operations can be used to clean up any proxy/stubs that are left after an abnormal application termination. If another process is holding a proxy to an object that is no longer available, due to application termination, it will start receiving RPC errors indicating that the object is gone. If the application fails to call unregister operations, then the global list that maintains the mapping between HWND, service identifier and the file mapping handle will be leaked (as a heap leak), but that will be reclaimed by the OS when the application terminates.

The enhanced IPC techniques implemented by the IPC system 100 in general and the IPC component 130 in particular provides various advantages over conventional IPC techniques. For example, the enhanced IPC techniques enable applications to advertise interfaces and services at an HWND level. In another example, the enhanced IPC techniques enable applications to remove or change advertisement of interfaces and services dynamically at runtime. In yet another example, the enhanced IPC techniques allow resource reclamation. In still another example, the enhanced IPC techniques are resilient to poor application design. In yet another example, the enhanced IPC techniques allow for scenarios where if an application terminates normally (does not crash), but the application fails to release resources correctly, then the resources allocated by this feature are reclaimable by the operating system. In still another example, the enhanced IPC techniques are resilient to application crashes. In yet another example, the enhanced IPC techniques allow for scenarios where if an application terminates abnormally, the HWND interface contract should be cleaned up by the operating system. Finally, the enhanced IPC techniques provide the ability to manage security. These are merely examples, and the enhanced IPC techniques provide other advantages as well.

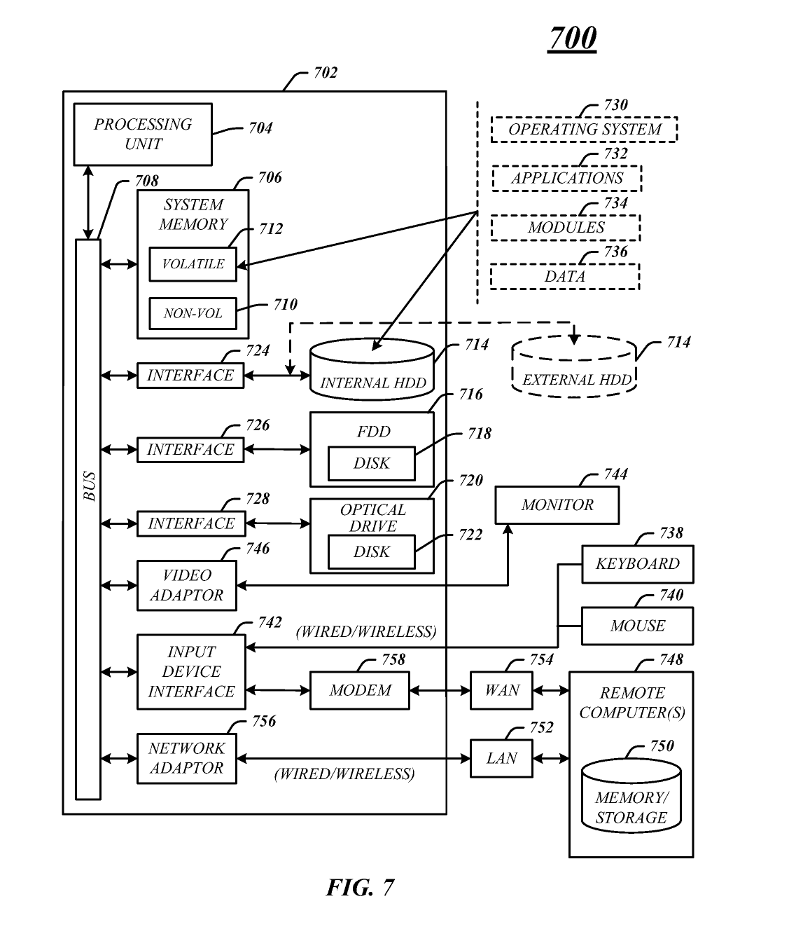

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, the IPC system 100, the application program 110, the system program 120, the IPC component 130, the object association component 132, the memory mapped file 134, and the object discovery component 136, among other elements.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
creating an application object for an application program executing in a first process, the application object having an application object interface;
initiating creation of a system object for a system program executing in a second process, the system object having a system object handle;
mapping the application object interface and the system object handle;
creating a memory map file name for a memory mapped file; and
storing a record with the mapping information in the memory mapped file.

2. The computer-implemented method of claim 1, comprising creating the memory map file name as a unique value creatable by both the application program and the system program.

3. The computer-implemented method of claim 1, comprising creating the memory map file name using the system object handle.

4. The computer-implemented method of claim 1, comprising creating the memory map file name using an application program interface arranged to receive as input the system object handle and output the memory map file name.

5. The computer-implemented method of claim 1, comprising creating a header for the mapping information.

6. The computer-implemented method of claim 1, comprising creating a header for the mapping information, the header comprising a signature, a size for the mapping information, and a service identifier.

7. The computer-implemented method of claim 1, comprising storing the record with a header before the mapping information in the memory mapped file.

8. The computer-implemented method of claim 1, comprising storing a second record with mapping information in the memory mapped file.

9. The computer-implemented method of claim 1, storing a third record with a terminator in the memory mapped file.

10. An article comprising a storage medium containing instructions that when executed enable a system to:
receive a service request for an application object;
determine a system object handle for a system object;
create a memory map file name for a memory mapped file using the system object handle; and
retrieve a record with mapping information from the memory mapped file, the mapping information representing a mapping between an application object interface for the application object of an application program executing in a first process and the system object handle for the system object of a system program executing in a second process.

11. The article of claim 10, further comprising instructions that when executed enable the system to create a memory map file name for a memory mapped file using the system object handle and without communicating with the application program.

12. The article of claim 10, the record with mapping information comprising a header for the mapping information, the header comprising a signature, a size for the mapping information, and a service identifier.

13. The article of claim 10, further comprising instructions that when executed enable the system to establish an inter-process communication (IPC) connection between the application object and the system object using the mapping information.

14. The article of claim 10, further comprising instructions that when executed enable the system to send an instruction to the application object over an IPC connection between the application object and the system object using the mapping information.

15. An apparatus, comprising:
a processor; and
a memory communicatively coupled to the processor, the memory to store an inter-process communications component having an object association component that when executed by the processor is operative to generate mapping information representing a mapping between an application object interface for an application object of an application program executing in a first process with a system object handle for a system object of a system program executing in a second process, create a memory map file name for a memory mapped file, and store a record with the mapping information in the memory mapped file.

16. The apparatus of claim 15, comprising an object discovery component operative to receive a service request, determine the system object handle, create the memory map file name for the memory mapped file using the system object handle, and retrieve the record with mapping information from the memory mapped file.

17. The apparatus of claim 15, comprising an object discovery component operative to establish a message connection between the application object and the system object using an application interface identifier (IID) from the mapping information.

18. The apparatus of claim 15, the memory mapped file storing a record with a header for the mapping information, the header comprising a signature, a size for the mapping information, and a service identifier.

19. The apparatus of claim 15, the memory mapped file storing a second record with a second header and second set of mapping information.

20. The apparatus of claim 15, the memory mapped file storing a file terminator in the memory mapped file to indicate an end for the memory mapped file.
